(19) United States
(12) Patent Application Publication
(10) Pub. No.: US 2026/0163658 A1
(43) Pub. Date: Jun. 11, 2026

(54) BLUETOOTH TRANSCEIVER SELF-TESTS FOR IN-FLIGHT ENTERTAINMENT SYSTEMS

(71) Applicant: Panasonic Avionics Corporation, Irvine, CA (US)

(72) Inventors: Christopher LYLE, Trabuco Canyon, CA (US); Nirav PATEL, Fullerton, CA (US); Glen GEE, Irvine, CA (US); He ZHENG, Irvine, CA (US)

(21) Appl. No.: 18/976,066

(22) Filed: Dec. 10, 2024

(51) Int. Cl. H04B 17/29; H04L 43/065; H04L 67/12

(52) U.S. Cl. CPC H04B 17/297; H04L 43/065; H04L 67/12

(57) ABSTRACT

Systems and methods for performing wireless transceiver self-tests in an aircraft are described. An example method includes receiving, by an in-flight entertainment (IFE) system of a current seat on the aircraft, a message comprising an indication to perform a self-test for a wireless transceiver associated with the IFE system. A configuration in the message determines a first set of seats from which the current seat receives data and a second set of seats to which the current seat transmits data. The method then performs a first test for a receiver of the wireless transceiver and a second test for a transmitter of the wireless transceiver. Upon completion of the tests, the method transmits a report including an indication of whether the receiver is operational, an indication of whether the second test was completed, and a list of successful transmitters and failed transmitters associated with the first set of seats.

### TECHNICAL FIELD

This document is generally related to systems, methods, and apparatus to improve the user experience in commercial passenger vehicles such as airplanes, passenger trains, buses, cruise ships, and other forms of transportation.

### BACKGROUND

Hardware self-tests in commercial passenger vehicles are critical for ensuring the safety, reliability, and efficiency of transportation systems. These self-tests involve automated diagnostic procedures that continuously monitor and evaluate the performance of various vehicle components, such as the electronic control units and safety mechanisms. By conducting these self-tests, the vehicle can detect potential issues early, such as wear and tear, malfunctions, or deviations from optimal performance parameters. This proactive approach allows for timely maintenance and repairs, reducing the risk of breakdowns and enhancing passenger safety.

### SUMMARY

This patent document describes, among other things, various implementations for performing equipment self-tests in an aircraft. The methods and systems described herein advantageously enable maintenance personnel to systematically test all in-flight entertainment (IFE) systems in an effort without having to manually perform these procedures. In an example, the functionality of the Bluetooth® transceivers associated with the IFE systems, e.g., wireless transmission and reception, are tested by ground crew to ensure that all the hardware is in proper working condition prior to the start of each leg of the aircraft.

In an example aspect, a method of performing equipment self-tests in an aircraft is described. The method includes receiving, by a seatback in-flight entertainment (IFE) system associated with a current seat from a maintenance server on the aircraft, a message comprising an indication to perform a self-test for a wireless transceiver associated with the seatback IFE system and the current seat, and determining, based on a configuration in the message, a first set of seats from which the current seat is configured to perform a reception and a second set of seats to which the current seat is configured to perform a transmission. The method further includes performing, for the first set of seats, a first test for a receiver of the wireless transceiver, and performing, for the second set of seats, a second test for a transmitter of the wireless transceiver. In this example method, a duration of the first test is a first function of a historical average duration taken for performing the first test and a first randomized value associated with the current seat, and a duration of the second test is a second function of a historical average duration taken for performing the second test and a second randomized value associated with the current seat. The method further includes transmitting, to the maintenance server based on a completion of the first test and the second test, a report comprising (a) a first indication of whether the receiver is operational, (b) a second indication of whether the second test was completed, and (c) a list of successful transmitters and failed transmitters associated with the first set of seats.

In another example aspect, a system for performing equipment self-tests in an aircraft is described. The system includes a plurality of seats in the aircraft (with each seat being associated with a corresponding seatback in-flight entertainment (IFE) system), a ground server configured to transmit a message comprising an indication to perform a self-test for a wireless transceiver associated with the corresponding seatback IFE system, and an on-board maintenance server configured to receive the message comprising the indication and a configuration for determining a first set of seats from which a current seat is configured to perform a reception and a second set of seats to which the current seat is configured to perform a transmission. In this example system, the corresponding seatback IFE system for the current seat is configured to (i) perform, for the first set of seats, a first test for a receiver of the wireless transceiver, wherein a duration of the first test is a first function of a historical average duration taken for performing the first test and a first randomized value associated with the current seat, (ii) perform, for the second set of seats, a second test for a transmitter of the wireless transceiver, wherein a duration of the second test is a second function of a historical average duration taken for performing the second test and a second randomized value associated with the current seat, and (iii) transmit, to the on-board maintenance server based on a completion of the first test and the second test, a report comprising (a) a first indication of whether the receiver is operational, (b) a second indication of whether the second test was completed, and (c) a list of successful transmitters and failed transmitters associated with the first set of seats.

In yet another example aspect, an apparatus for performing equipment self-tests in an aircraft is described. The apparatus includes one or more processors of a maintenance server on the aircraft that are configured to receive, from a ground server external to the aircraft, a first message comprising an indication for a seatback in-flight entertainment (IFE) system associated with each of a plurality of seats in the aircraft to perform a self-test for a wireless transceiver associated with the seatback IFE system and a corresponding seat. Then, the one of more processors transmit, to each wireless transceiver, a second message comprising the indication and a configuration that enables the corresponding seat to determine a first set of seats from which the corresponding seat is configured to perform a reception and a second set of seats to which the corresponding seat is configured to perform a transmission. In this example, the seatback IFE system is configured to (a) perform, for the first set of seats, a first test for a receiver of the each wireless transceiver (with a duration of the first test being a first function of a historical average duration taken for performing the first test and a first randomized value associated with the corresponding seat), and (b) perform, for the second set of seats, a second test for a transmitter of the each wireless transceiver (with a duration of the second test is a second function of a historical average duration taken for performing the second test and a second randomized value associated with the corresponding seat). The one or more processors is further configured to receive, from the each wireless transceiver and based on a completion of the first test and the second test, a report comprising (a) a first indication of whether the receiver is operational, (b) a second indication of whether the second test was completed, and (c) a list of successful transmitters and failed transmitters associated with the first set of seats.

In yet another example aspect, the above-described method is embodied in the form of processor-executable code and stored in a computer-readable program medium.

In yet another example aspect, a device that is configured or operable to perform the above-described method is disclosed.

The above and other aspects and their implementations are described in greater detail in the drawings, the description, and the claims.

### BRIEF DESCRIPTION OF THE DRAWINGS

FIG. 1 shows an architecture of an example system that improves performing equipment self-tests in an aircraft, in accordance with embodiments of the disclosed technology.

FIG. 2 shows a timing diagram of an example method for performing ground crew-activated self-tests of Bluetooth transceivers on an aircraft.

FIG. 3A shows a timing diagram of another example method for performing on-board crew-activated Bluetooth transceiver self-tests on the aircraft.

FIGS. 3B and 3C show timing diagrams for the receiver (RX) and transmitter (TX) self-tests, respectively, associated with the example method shown in FIG. 3A.

FIGS. 4A and 4B show different configurations for implementing the self-tests.

FIG. 5 shows a flowchart for an example method performing self-tests of Bluetooth transceivers on an aircraft.

FIG. 6 shows a block diagram of an example computing device based on some implementations of the disclosed technology.

### DETAILED DESCRIPTION

Wireless headphones (e.g., Bluetooth®-enabled earbuds) significantly enhance the travel experience by offering several advantages over traditional wired headphones. The absence of cables allows passengers to move freely without the hassle of tangled wires, making it easier to get in and out of airplane seats or reach for items in a bag. This freedom of movement, combined with the convenience of not having to constantly adjust or untangle cords, contributes to a more comfortable journey. Wireless headphones often provide superior sound quality compared to standard plug-in earbuds, with features like noise cancellation reducing ambient noise for better inflight entertainment. Seamless connectivity to multiple devices allows passengers to switch between smartphones, tablets, and inflight systems effortlessly. Enhanced communication is another benefit, as passengers can hear announcements without removing their headphones. With long battery life and portability, modern wireless headphones ensure they last through long flights and are easy to carry, making them a more convenient and enjoyable option.

However, the above-mentioned advantages of wireless headphones are only realized if the hardware on the aircraft, e.g., in-flight entertainment (IFE) system, supports the specific wireless technology, e.g., Bluetooth or Wi-Fi®, and is operating and functioning properly.

Embodiments of the disclosed technology provide significant advantages for maintenance personnel by enabling them to systematically test Bluetooth transceivers in all the IFE systems on the aircraft in an automated manner. This approach eliminates the need for manual intervention, thereby streamlining the testing process and ensuring comprehensive coverage of all IFE components. By automating these procedures, maintenance teams can achieve higher efficiency and accuracy, reducing the likelihood of human error and ensuring that all systems are functioning correctly before flight. This not only enhances the reliability and performance of the IFE systems but also contributes to overall passenger satisfaction by ensuring a seamless entertainment experience. Additionally, the automated testing process can save time and resources, allowing maintenance personnel to focus on other critical tasks.

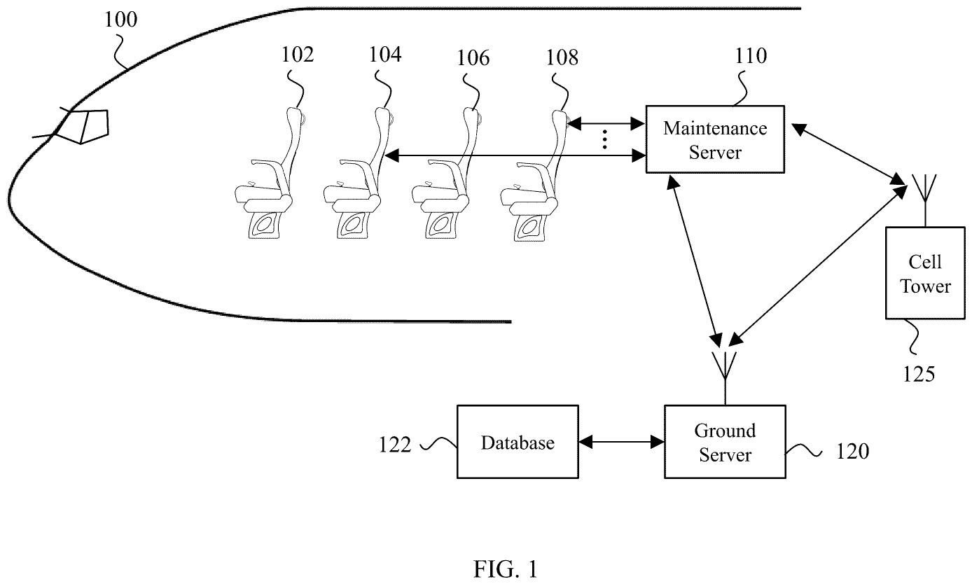

FIG. 1 shows an architecture of an example system that improves performing equipment self-tests in an aircraft. As shown therein, the aircraft 100 includes multiple seats (102, 104, 106, 108, . . . ), each of which includes an IFE system. In some examples, the IFE system includes a seatback screen that is mounted to the back of the seat, one or more control units (e.g., a handheld remote control (with or without a touchpad) or a touchscreen interface on the seatback screen), and a seat electronic box (SEB) that houses the electronics that control the seatback screen, amongst other components. Each of the seats is communicatively coupled with a maintenance server 110 on the aircraft, which is in communication with a ground server 120. As shown in FIG. 1, the maintenance server 110 is communicatively coupled with the ground server 120 directly (e.g., using Bluetooth, Bluetooth LE, NFC, Zigbee, etc.) and via the cellular network that relies on a cell tower 125. In this example, the ground server 120 interacts with a database 122 that stores configuration information related to performing the equipment self-tests.

In some embodiments, each of the components in the aircraft (e.g., the IFE system associated with each seat 102, 104, . . . , and the maintenance server 110) is a line replaceable unit (LRU), which is a modular component that can be quickly replaced at the operational level without the need for specialized tools or extensive maintenance. LRUs minimize downtime by enabling quick component swaps, simplify maintenance with standardized, easily accessible units, and reduce costs through efficient labor and inventory management.

In the described embodiments, each IFE system includes a wireless transmitter (e.g., a Bluetooth transmitter) and a wireless receiver (e.g., a Bluetooth receiver) that must remain operational in order for the passengers to be able to use their wireless headphones. Furthermore, in some embodiments, the IFE system includes both an interactive screen (or monitor) and a handheld tablet, whereas in other embodiments, the IFE system only includes the interactive screen. In some examples, the interactive screen can be part of the ELITE or HDPSEB product lines developed by Panasonic Avionics Corp. of Lake Forest, California, and the handheld tablet can be part of the IPSC product line (also developed by Panasonic Avionics Corp.).

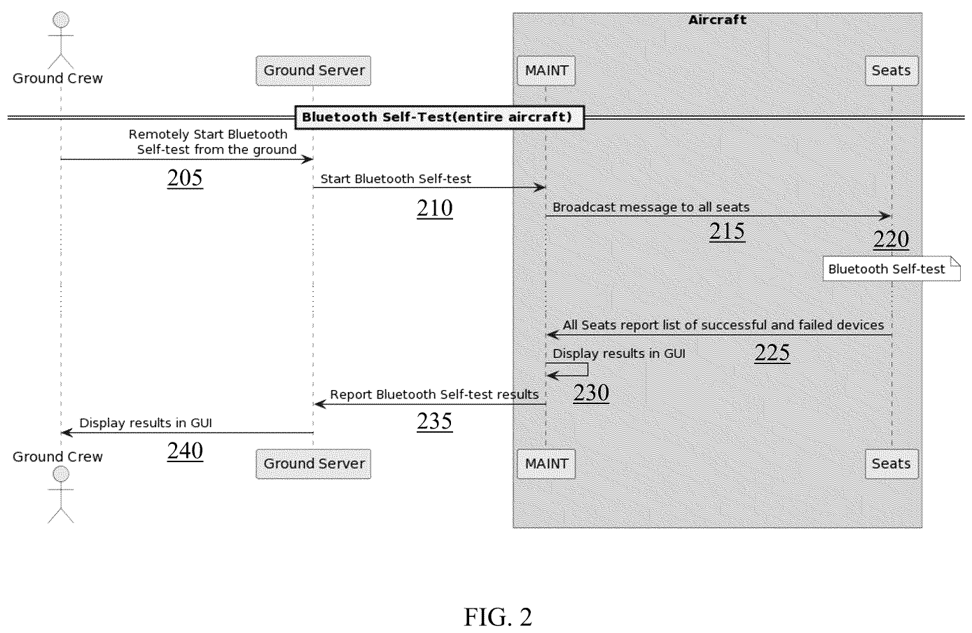

FIG. 2 shows a timing diagram of an example method for performing self-tests of Bluetooth transceivers on an aircraft (e.g., aircraft 100 in FIG. 1), with the self-tests being initiated by a ground crew. As shown in FIG. 2, the method includes (205) the ground crew remotely starting the Bluetooth self-test by transmitting a message to the ground server (e.g., ground server 120 in FIG. 1), which then (210) sends a message to the maintenance server (e.g., maintenance server 110 in FIG. 1) on the aircraft. The message includes an indication to start the self-tests for Bluetooth transceivers associated with the IFE systems on each of the seats (e.g., seats 102, 104, 106, and 108 in FIG. 1) in the aircraft.

On the aircraft, (215) the maintenance server broadcasts the received indication to each seat in the aircraft, which (220) performs the Bluetooth transceiver self-test and (225) report a list of successful and failed devices to the maintenance server. The method then includes (230) the maintenance server (230) displays the results via a GUI on the aircraft (e.g., to allow an on-board crew member who is preparing for departure to confirm that all Bluetooth transceivers on the aircraft are working as intended), and (235) reports the results of the Bluetooth self-tests to the ground server. Similar to the capabilities of the maintenance server, the ground server (240) can display the results using a GUI that is accessible to the ground crew.

In some embodiments, the Bluetooth self-test for the transceiver is implemented by placing it in repeating pattern of a discovery mode (for the transmitter self-test) and a scanning mode (for the receiver self-test). Furthermore, random intervals are used to ensure that different phases do not always overlap between neighboring devices.

In some embodiments, the results of the Bluetooth self-tests include Boolean values indicative of the operational status of the transmitter and receiver for each Bluetooth transceiver of an IFE system of each seat on the aircraft. The results can additionally include a signal strength metric (e.g., signal-to-noise ratio (SNR) or received signal strength indicator (RSSI)) for a received signal, and corresponding to a transmitter of another seat. The signal strength metric results from multiple receivers can be averaged (e.g., simple average, weighted average with the weights being determined based on the seat configuration) to determine a Bluetooth transmission radius for the transmitter of each Bluetooth receiver. The radius information can be overlaid on an aircraft seat map, and displayed on the GUI for both crew members (via the maintenance server) and the ground crew (via the ground server).

In some embodiments, the radius information received from each of the seats on the aircraft can be used to perform a negative test of seats that a receiver seat should not be configured to communicate with. For example, by examining transmission radii corresponding to seats in first class, the cabin crew can ensure that no Bluetooth transmissions from any first-class seats reach any seat in economy class. For instance, first class seats may have a significantly higher data cap for the flight, and would therefore be able to stream movies at a higher data rate through the duration of the entire flight. This high-bandwidth data stream could act as persistent wireless interference to Bluetooth transceivers in economy class if they were both using the same frequency band (e.g., 2.4 GHz), which could lead to signal dropouts or pairing problems.

In some embodiments, operation 230 can include the maintenance server tracking the reports received from the seats, and updating a progress bar for the Bluetooth transceiver self-tests using the GUI for the crew members. This enables the crew members to better coordinate their other tasks and duties, and estimate when the plane will be ready for passenger boarding.

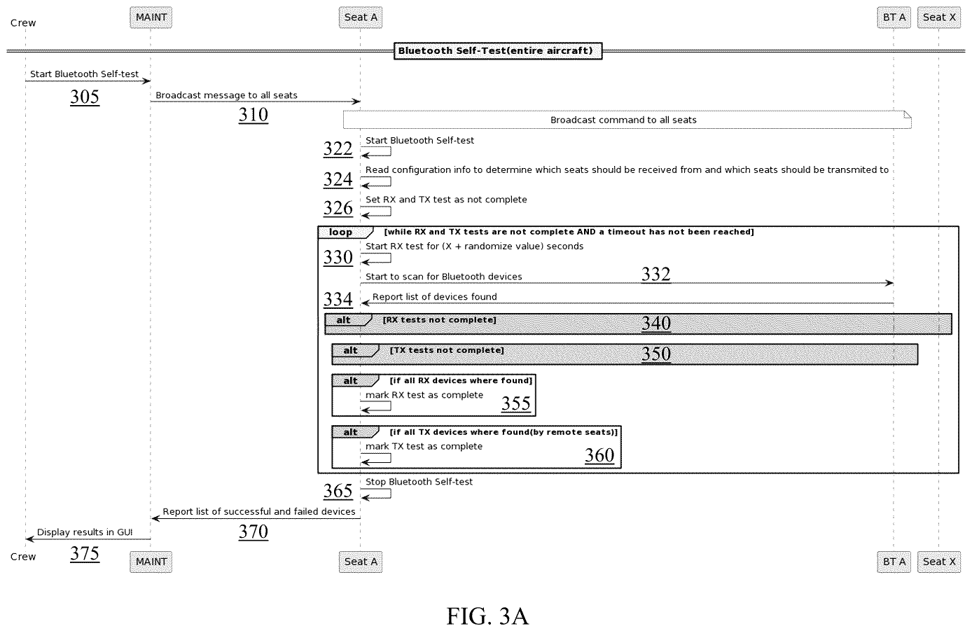

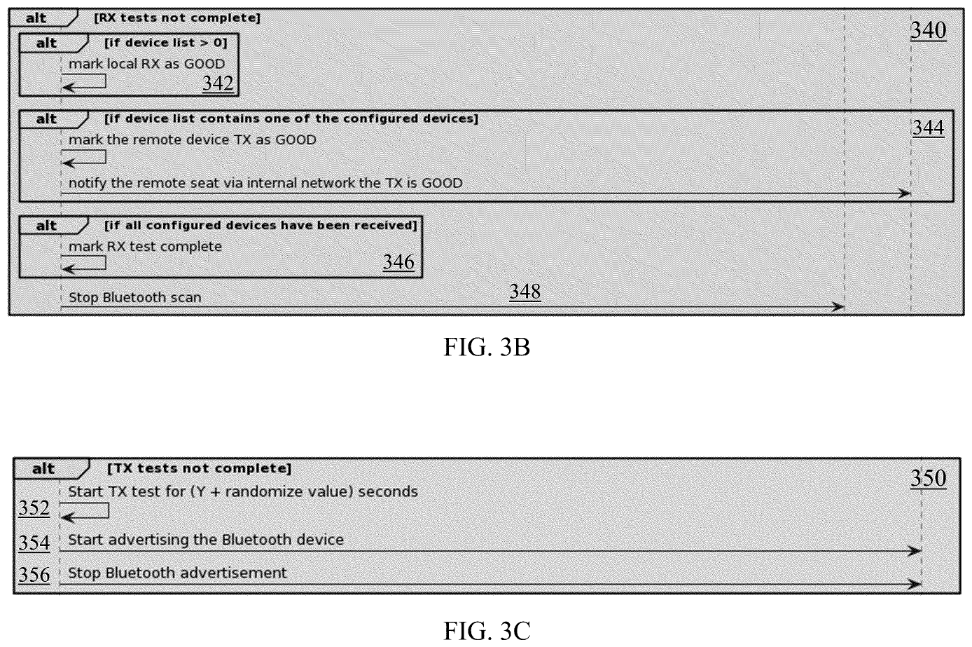

FIG. 3A shows a timing diagram of an example method for performing on-board crew-activated Bluetooth transceiver self-tests on the aircraft. As shown therein, the method begins with (305) the crew starting the Bluetooth self-test by sending a message to the maintenance server, which then (310) broadcasts the message to each seat in the aircraft. In some examples, the message includes an indication to start the Bluetooth transceiver self-tests and configuration information for each seat (e.g., seat A) specifying a first set of seats configured to transmit to Seat A, and a second set of seats configured to receive transmissions from Seat A.

In some embodiments, the message received by the maintenance server includes only the indication, and the maintenance server adds configuration information prior to broadcasting the message to each of the seats on the aircraft.

On the aircraft, and using Seat A as an example, the IFE system on seat A (322) starts the Bluetooth self-tests, (324) reads the configuration information in the message to determine which seats should be received from (e.g., the first set of seats) and which seats should be transmitted to (e.g., the second of seats), and (326) sets Boolean variables indicating the self-tests for the receiver (RX) and the transmitter (TX) are not complete (e.g., RX_Test_Not_Complete and TX_Test_Not_Complete) to true. In some examples, a timeout variable (e.g., BT_Self-Test_Timeout) is defined to set a maximum duration for the Bluetooth self-tests (e.g., so as to not impact the aircraft departure timeline).

In some embodiments, and as shown in FIG. 3A, the Bluetooth transceiver self-tests for all the seats on the aircraft are performed using a [while] loop based on the above-defined Boolean values and a timer not having reached the timeout value. In other embodiments, the self-tests can be performed using a [for] loop that iterated over all the seats, and the timeout value being defined to set the maximum duration for each Bluetooth self-test.

As shown in FIG. 3A, the IFE system of Seat A (330) starts the RX test for a duration equaling a function of a historical average duration taken for performing the RX test and a randomized value associated with the current seat, and (332) indicates to the Bluetooth transceiver for Seat A to start scanning for Bluetooth devices. Alternatively, the randomized value can be used as a random backoff to begin the RX test (e.g., similar to the functionality of random backoff timer used in Wi-Fi), and would not rely on the historical average duration in this implementation. Using a randomized value (e.g., randomized for each seat) ensures different phases do not always overlap between neighboring devices. In some examples, the historical average duration is an arithmetic mean of a predetermined number of previous RX tests, e.g., the average duration of the last twenty or fifty RX tests. Alternatively, the historical average duration is computed using a weighted average of a predetermined number of previous RX tests. In this example, a forgetting factor can be employed to weight more recent RX tests more heavily than older RX tests (that are weighted less heavily) when determining the historical average duration.

The IFE system (334) receives a report, from the Bluetooth transceiver of Seat A, of the list of devices found. The IFE system then (340) determines whether the RX tests are complete and (350) whether the TX test are complete. If the IFE system (355) determines that all the RX devices were found, the RX test is marked as complete, and, if (360) the TX device was found (by remote seats), the TX test is marked as complete, and (365) the Bluetooth self-test for Seat A is stopped.

The IFE system then (370) reports the list of successful and failed devices to the on-board maintenance server, which (375) displays the results using a graphical user interface (GUI).

FIG. 3B shows a timing-diagram for (340) determining that the RX tests are not completed (e.g., RX_Test_Not_Complete is equal to true). As shown therein, (342) if the device list has been populated (e.g., the receiver has received a transmission from at least one seat), the RX of the Bluetooth transceiver of Seat A is marked as GOOD. Then, (344) if the device list contains one of the configured devices (e.g., the RX has received a transmission from one of the first set of seats), the TX corresponding to that seat is marked as GOOD, and this is notified to that seat (e.g., via the internal network). The IFE system (346) determining that receptions from all configured devices (e.g., all devices in the first set of seats) have been confirmed, the RX test is marked as complete, and (348) the Bluetooth scan is stopped. Additionally, Boolean variable RX_Test_Not_Complete is set to false.

FIG. 3C shows a timing diagram for (350) determining the TX test is not completed (e.g., TX_Test_Not_Complete is equal to true). As shown therein, IFE system of Seat A (352) starts the TX test for a duration equaling a function of a historical average duration taken for performing the TX test and a randomized value associated with the current seat, (354) starts advertising the Bluetooth device, and subsequently, (356) stops the Bluetooth advertisement.

In some embodiments, the randomized values used for the RX tests and the TX tests are drawn from the same random distribution (e.g., a Poisson or Gaussian distribution). In other embodiments, different random distributions are used to generate the randomized values for the RX tests and the TX tests (e.g., different distributions or different parameters).

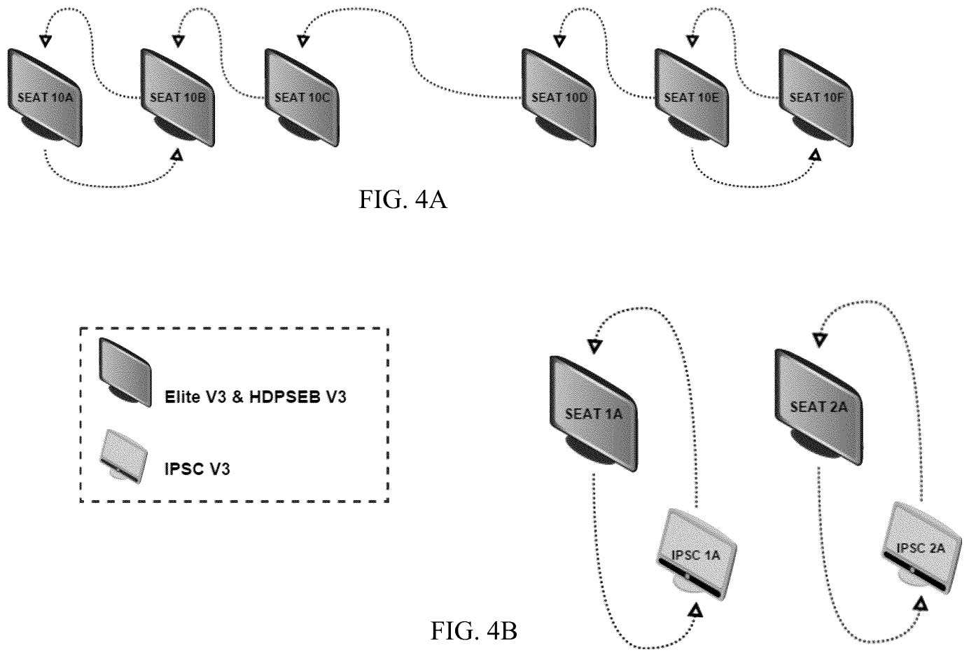

In some embodiments, the IFE system includes only an interactive screen, and the configuration for the Bluetooth self-tests is as shown in FIG. 4A. As shown therein, each seat in a row receives a transmission from the seat to its right (except for the last seat on the right, which receives a transmission from the seat from its left), and transmits to the seat on its left (except for the last seat on the left, which transmits to the seat on it right).

In some examples, the configuration for the Bluetooth transceiver self-tests for the example in FIG. 4A, where “SCR” refers to the interactive screen, is shown below:
SCR 10A: Receive from SCR 10B; Transmit to SCR 10B;
SCR 10B: Receive from SCR 10C, SCR 10A; Transmit to SCR 10A;
SCR 10C: Receive from SCR 10D; Transmit to SCR 10B;
SCR 10D: Receive from SCR 10E; Transmit to SCR 10C;
SCR 10E: Receive from SCR 10F; Transmit to SCR 10D, 10F;
SCR 10F: Receive from SCR 10E; Transmit to SCR 10E;

In the above configuration, each interactive screen (e.g., SCR 10A through SCR 10F) can be accessed via a unique identifier, e.g., an IPv4 or IPv6 address or a MAC address.

In some embodiments, the IFE system includes both an interactive screen and a handheld tablet, and the configuration for the Bluetooth self-tests is as shown in FIG. 4B. As shown therein, each Bluetooth transceiver for interactive screen will transmit to and receive from the other Bluetooth transceiver for the handheld tablet.

In some examples, the configuration for the Bluetooth transceiver self-tests for the example in FIG. 4B, where “SCR” is used to denote the interactive screen and “TAB” is used to denote the handheld tablet, is shown below:
SCR 1A: Receive from TAB 1A; Transmit to TAB 1A;
TAB 1A: Receive from SCR 1A; Transmit to SCR 1A;
SCR 2A: Receive from TAB 2A; Transmit to TAB 2A;
TAB 2A: Receive from SCR 2A; Transmit to SCR 2A;

In the above configuration, each interactive screen (e.g., SCR 1A and SCR 2A) and each handheld tablet (e.g., TAB 1A and TAB 2A) can be accessed via a unique identifier, e.g., an IPv4 or IPv6 address or a MAC address.

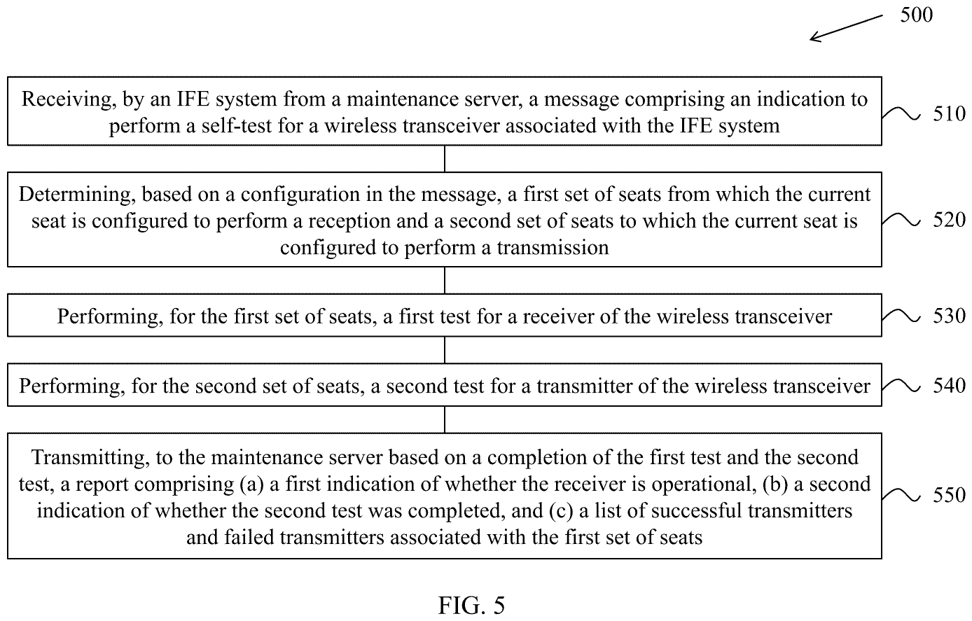

FIG. 5 shows a flowchart of an example method 500 for performing equipment self-tests in an aircraft based on some implementations of the disclosed technology. The method 500 includes, at operation 510, receiving, by a seatback in-flight entertainment (IFE) system (or simply, an IFE system) associated with a current seat from a maintenance server on the aircraft, a message comprising an indication to perform a self-test for a wireless transceiver associated with the seatback IFE system and the current seat.

The method 500 includes, at operation 520, determining, based on a configuration in the message, a first set of seats from which the current seat is configured to perform a reception and a second set of seats to which the current seat is configured to perform a transmission.

The method 500 includes, at operation 530, performing, for the first set of seats, a first test for a receiver of the wireless transceiver. Herein, a duration of the first test is a first function of a historical average duration taken for performing the first test and a first randomized value associated with the current seat.

The method 500 includes, at operation 540, performing, for the second set of seats, a second test for a transmitter of the wireless transceiver. Herein, a duration of the second test is a second function of a historical average duration taken for performing the second test and a second randomized value associated with the current seat.

The method 500 includes, at operation 550, transmitting, to the maintenance server based on a completion of the first test and the second test, a report comprising (a) a first indication of whether the receiver is operational, (b) a second indication of whether the second test was completed, and (c) a list of successful transmitters and failed transmitters associated with the first set of seats.

In some embodiments, performing the first test includes the receiver performing a scan for configured wireless devices associated with each of the first set of seats, and generating, based on the scan detecting one or more advertising messages, a list of reachable wireless devices associated with the first set of seats. Performing the first test further includes determining (a) when the list of reachable wireless devices includes at least one wireless device, that the receiver is operational and setting the first indication thereto, and (b) when a wireless device is both a configured wireless device and on the list of reachable wireless devices, that the wireless device comprises a successful transmitter, and otherwise, that the wireless device comprises a failed transmitter. In some examples, the first test is described in FIGS. 3A and 3B.

In some embodiments, performing the second test includes periodically transmitting, by the transmitter, an advertising message for a predetermined duration or a predetermined number of transmissions, and after the predetermined duration or the predetermined number of transmissions, (a) refraining from transmitting the advertising message, and (b) determining the second test is completed and setting the second indication thereto. In some examples, the second test is described in the context of FIGS. 3A and 3C.

In some embodiments, the wireless transceiver is a Bluetooth® transceiver.

In some embodiments, the seatback IFE system of the current seat comprises a GUI (e.g., an interactive screen) associated with a first wireless transceiver and an integrated handheld device (e.g., a handheld tablet) associated with a second wireless transceiver (corresponding to the configuration shown in FIG. 4B). In these embodiments, the seatback IFE system of the current seat performing the first test comprises (a) transmitting, by a transmitter of the second wireless transceiver of the integrated handheld device to a receiver of the first wireless transceiver of the GUI, one or more messages, and (b) receiving, by the receiver of the first wireless transceiver of the GUI from the transmitter of the second wireless transceiver of the integrated handheld device, the one or more messages. In these embodiments, the seatback IFE system of the current seat performing the second test comprises (a) transmitting, by a transmitter of the first wireless transceiver of the GUI to a receiver of the second wireless transceiver of the integrated handheld device, one or more advertising messages comprising connectivity information for the first wireless transceiver.

In some embodiments, the seatback IFE system of the current seat excludes an integrated handheld device (e.g., corresponding to the configuration shown in FIG. 4A). In these embodiments, the seatback IFE system of the current seat performing the first test comprises receiving, by the receiver of the wireless transceiver associated with the current seat, one or more messages from a first wireless transceiver associated with a first adjacent seat located rightward from the current seat. In these embodiments, the seatback IFE system of the current seat performing the second test comprises transmitting, by the transmitter of the wireless transceiver associated with the current seat, the one or more messages to a second wireless transceiver associated with a second adjacent seat located leftward from the current seat.

In some embodiments, the maintenance server is associated with a GUI, and the maintenance server is configured to overlay, based on the report, an operational status for each seatback IFE system associated with a seat upon a seating chart of the aircraft.

In some embodiments, the maintenance server is configured, upon receiving the report from each seatback IFE system associated with each seat on the aircraft, to update a graphical user interface (GUI) by overlaying an operational status for each seatback IFE system associated with a seat upon a seating chart of the aircraft. Herein, the operational status comprises a first graphical indication indicative of the operational status of the transmitter of the wireless transceiver associated with the corresponding seat and a second graphical indication indicative of the operational status of the receiver associated with the corresponding seat. In some examples, updating the GUI comprises determining a transmission radius for the transmitter of each wireless transceiver, and overlaying a representation of the transmission radius on the corresponding seat. In other examples, updating the GUI, prior to receiving the report from all seats on the aircraft, comprises updating a progress bar indicative of a number of seats from which the maintenance server has received the report.

In some embodiments, the maintenance server is configured to determine that a transmission radius of any seat in a first-class seating section of the aircraft excludes a seat in an economy-class seating section of the aircraft.

In some embodiments, the maintenance server is triggered to transmit the second message by a crew member of the aircraft or by the ground server.

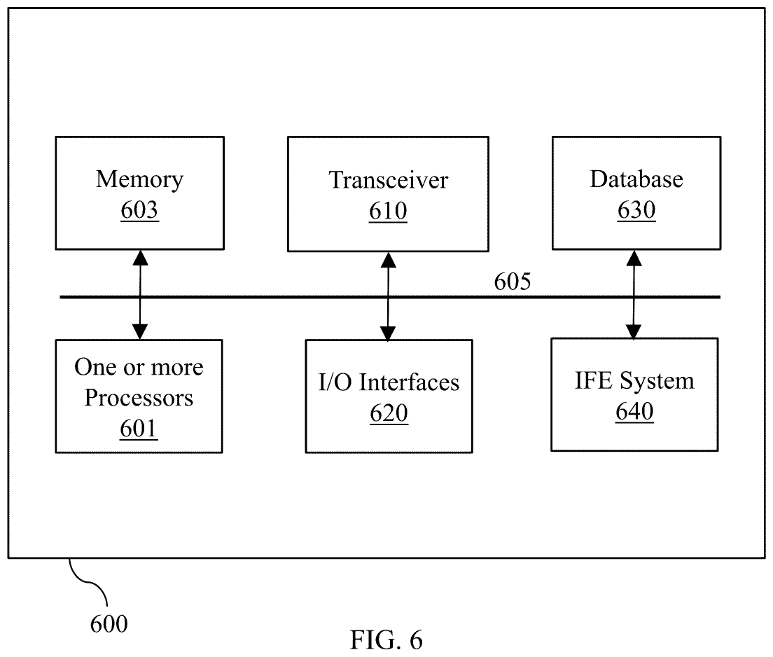

FIG. 6 shows an example architecture of a device 600 that can be used to perform equipment self-tests in an airplane. As shown therein, the device may include one or more processors 601 and a memory 603, which are connected to a bus 605. In an example, the bus 605 may be a Controller Area Network (CAN) bus. In another example, the bus 605 may be an avionics data bus (e.g., ARINC 429, 615, 629 or 664). The one or more processors 601 and the memory 603 are further connected, via the bus 605, to at least a transceiver 610, input/output (I/O) interfaces 620, a database 630 and an in-flight entertainment (IFE) system 640.

In some embodiments, one or more of the components of the device 600, shown in FIG. 6, may be combined, or implemented independently in another device. For example, the IFE system 640 may not be directly connected to the bus 605, but may be connected to a different bus (not shown in FIG. 6) that can communicate (either through a wired or wireless connection) with bus 605. For another example, the database 630 or the transceiver 610 may be part of the IFE system 640, instead of a separate component. For another example, the database 630 could include multiple databases. Alternative embodiments of the architecture shown in FIG. 6, which advantageously enable performing wireless transceiver self-tests in an airplane, include various combinations of the components shown therein.

In some embodiments, the transceiver 610 corresponds to the wireless Bluetooth transceiver of the IFE system. In other embodiments, the database 630 stores configuration information (e.g., received from the maintenance server) for an IFE system in each seat, which includes a first set of seats from which a current seat is configured to perform a reception and a second set of seats to which the current seat is configured to perform a transmission. In yet other embodiments, the transceiver and the database may be internal components of the IFE system 640. In yet other embodiments, the memory 603 may include the logically separated storage segments that store the avionics software and media content. In yet other embodiments, the I/O interfaces 620 include hardware/software components that enable the IFE system to communicate with the external system (e.g., ground server 120 in FIG. 1).

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware, or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this patent document.

What is claimed is:

1. A method of performing equipment self-tests in an aircraft, comprising:
receiving, by a seatback in-flight entertainment (IFE) system associated with a current seat from a maintenance server on the aircraft, a message comprising an indication to perform a self-test for a wireless transceiver associated with the seatback IFE system and the current seat;
determining, based on a configuration in the message, a first set of seats from which the current seat is configured to perform a reception and a second set of seats to which the current seat is configured to perform a transmission;
performing, for the first set of seats, a first test for a receiver of the wireless transceiver, wherein a duration of the first test is a first function of a historical average duration taken for performing the first test and a first randomized value associated with the current seat;
performing, for the second set of seats, a second test for a transmitter of the wireless transceiver, wherein a duration of the second test is a second function of a historical average duration taken for performing the second test and a second randomized value associated with the current seat; and
transmitting, to the maintenance server based on a completion of the first test and the second test, a report comprising (a) a first indication of whether the receiver is operational, (b) a second indication of whether the second test was completed, and (c) a list of successful transmitters and failed transmitters associated with the first set of seats.

2. The method of claim 1, wherein performing the first test comprises:
performing, by the receiver, a scan for configured wireless devices associated with each of the first set of seats;
generating, based on the scan detecting one or more advertising messages, a list of reachable wireless devices associated with the first set of seats; and
determining:
when the list of reachable wireless devices includes at least one wireless device, that the receiver is operational and setting the first indication thereto, and
when a wireless device is both a configured wireless device and on the list of reachable wireless devices, that the wireless device comprises a successful transmitter, and otherwise, that the wireless device comprises a failed transmitter.

3. The method of claim 1, wherein performing the second test comprises:
periodically transmitting, by the transmitter, an advertising message for a predetermined duration or a predetermined number of transmissions; and
after the predetermined duration or the predetermined number of transmissions:
refraining from transmitting the advertising message, and
determining the second test is completed and setting the second indication thereto.

4. The method of claim 1, wherein the wireless transceiver is a Bluetooth® transceiver.

5. The method of claim 1, wherein the seatback IFE system of the current seat comprises a graphical user interface (GUI) associated with a first wireless transceiver and an integrated handheld device associated with a second wireless transceiver.

6. The method of claim 5, wherein the seatback IFE system of the current seat performing the first test comprises:
transmitting, by a transmitter of the second wireless transceiver of the integrated handheld device to a receiver of the first wireless transceiver of the GUI, one or more messages; and
receiving, by the receiver of the first wireless transceiver of the GUI from the transmitter of the second wireless transceiver of the integrated handheld device, the one or more messages.

7. The method of claim 5, wherein the seatback IFE system of the current seat performing the second test comprises:
transmitting, by a transmitter of the first wireless transceiver of the GUI to a receiver of the second wireless transceiver of the integrated handheld device, one or more advertising messages comprising connectivity information for the first wireless transceiver.

8. The method of claim 1, wherein the seatback IFE system of the current seat excludes an integrated handheld device.

9. The method of claim 8, wherein the seatback IFE system of the current seat performing the first test comprises:
receiving, by the receiver of the wireless transceiver associated with the current seat, one or more messages from a first wireless transceiver associated with a first adjacent seat located rightward from the current seat.

10. The method of claim 9, wherein the seatback IFE system of the current seat performing the second test comprises:
transmitting, by the transmitter of the wireless transceiver associated with the current seat, the one or more messages to a second wireless transceiver associated with a second adjacent seat located leftward from the current seat.

11. A system for performing equipment self-tests in an aircraft, comprising:
a plurality of seats in the aircraft, wherein each seat is associated with a corresponding seatback in-flight entertainment (IFE) system;
a ground server configured to transmit a message comprising an indication to perform a self-test for a wireless transceiver associated with the corresponding seatback IFE system; and
an on-board maintenance server configured to receive the message comprising the indication and a configuration for determining a first set of seats from which a current seat is configured to perform a reception and a second set of seats to which the current seat is configured to perform a transmission,
wherein the corresponding seatback IFE system for the current seat is configured to:
perform, for the first set of seats, a first test for a receiver of the wireless transceiver, wherein a duration of the first test is a first function of a historical average duration taken for performing the first test and a first randomized value associated with the current seat;
perform, for the second set of seats, a second test for a transmitter of the wireless transceiver, wherein a duration of the second test is a second function of a historical average duration taken for performing the second test and a second randomized value associated with the current seat; and
transmit, to the on-board maintenance server based on a completion of the first test and the second test, a report comprising (a) a first indication of whether the receiver is operational, (b) a second indication of whether the second test was completed, and (c) a list of successful transmitters and failed transmitters associated with the first set of seats.

12. The system of claim 11, wherein the wireless transceiver is a Bluetooth® transceiver.

13. The system of claim 11, wherein the maintenance server is associated with a graphical user interface (GUI), and wherein the maintenance server is configured to overlay, based on the report, an operational status for each seatback IFE system associated with a seat upon a seating chart of the aircraft.

14. An apparatus for performing equipment self-tests in an aircraft, comprising:
one or more processors of a maintenance server on the aircraft that are configured to:
receive, from a ground server external to the aircraft, a first message comprising an indication for a seatback in-flight entertainment (IFE) system associated with each of a plurality of seats in the aircraft to perform a self-test for a wireless transceiver associated with the seatback IFE system and a corresponding seat; and
transmit, to each wireless transceiver, a second message comprising the indication and a configuration that enables the corresponding seat to determine a first set of seats from which the corresponding seat is configured to perform a reception and a second set of seats to which the corresponding seat is configured to perform a transmission,
wherein the seatback IFE system is configured to (a) perform, for the first set of seats, a first test for a receiver of the each wireless transceiver, wherein a duration of the first test is a first function of a historical average duration taken for performing the first test and a first randomized value associated with the corresponding seat, and (b) perform, for the second set of seats, a second test for a transmitter of the each wireless transceiver, wherein a duration of the second test is a second function of a historical average duration taken for performing the second test and a second randomized value associated with the corresponding seat, and
wherein the one or more processors is further configured to:
receive, from the each wireless transceiver and based on a completion of the first test and the second test, a report comprising (a) a first indication of whether the receiver is operational, (b) a second indication of whether the second test was completed, and (c) a list of successful transmitters and failed transmitters associated with the first set of seats.

15. The apparatus of claim 14, wherein the maintenance server is configured, upon receiving the report from each seatback IFE system associated with each seat on the aircraft, to:
update a graphical user interface (GUI) by overlaying an operational status for each seatback IFE system associated with a seat upon a seating chart of the aircraft, wherein the operational status comprises a first graphical indication indicative of the operational status of the transmitter of the wireless transceiver associated with the corresponding seat and a second graphical indication indicative of the operational status of the receiver associated with the corresponding seat.

16. The apparatus of claim 15, wherein updating the GUI comprises:
determining a transmission radius for the transmitter of each wireless transceiver; and
overlaying a representation of the transmission radius on the corresponding seat.

17. The apparatus of claim 15, wherein updating the GUI, prior to receiving the report from all seats on the aircraft, comprises:
updating a progress bar indicative of a number of seats from which the maintenance server has received the report.

18. The apparatus of claim 14, wherein the maintenance server is configured to:
determine that a transmission radius of any seat in a first-class seating section of the aircraft excludes a seat in an economy-class seating section of the aircraft.

19. The apparatus of claim 14, wherein the maintenance server is triggered to transmit the second message by a crew member of the aircraft or by the ground server.

20. The apparatus of claim 14, wherein the wireless transceiver is a Bluetooth® transceiver.
